(19) United States
(12) Patent Application Publication
(10) Pub. No.: US 2013/0130080 A1
(43) Pub. Date: May 23, 2013

(54) BATTERY PACK CASE

(71) Applicants: Chan YOON, Seoul (KR); Young Hak Jeong, Gyeonggi-do (KR); Hyun Chul Jung, Gyeonggi-do (KR); Bae Kyun Kim, Gyeonggi-do (KR)

(72) Inventors: Chan YOON, Seoul (KR); Young Hak Jeong, Gyeonggi-do (KR); Hyun Chul Jung, Gyeonggi-do (KR); Bae Kyun Kim, Gyeonggi-do (KR)

(73) Assignee: Samsung Electro-Mechanics Co., Ltd.

(21) Appl. No.: 13/426,317

(22) Filed: Mar. 21, 2012

(30) Foreign Application Priority Data
Nov. 17, 2011 (KR) 10-2011-0120269

(51) Int. Cl. H01M 10/50

(52) U.S. Cl. 429/83; 429/72

(57) ABSTRACT

A battery pack case includes at least one battery cell; a cooling case having inclinedly formed insertion parts into which the battery cells are inserted; and cooling passages provided in the cooling case and inclinedly formed so as to move a cooling medium between the battery cells.

### CROSS REFERENCE(S) TO RELATED APPLICATIONS

This application claims the benefit under 35 U.S.C. Section 119 of Korean Patent Application Serial No. 10-2011-0120269, entitled “Battery Pack Case” filed on Nov. 17, 2011, which is hereby incorporated by reference in its entirety into this application.

### BACKGROUND OF THE INVENTION

1. Technical Field

The present invention relates to a battery pack case, and more particularly, to a battery pack case capable of improving cooling performance of a battery by cooling a cell over a wide area.

2. Description of the Related Art

Generally, a secondary battery is a battery that can be charged and discharged unlike a primary cell that cannot perform charging. As a result, the secondary battery has been prevalently used as a power supply driving various portable electronic devices such as a mobile phone, a notebook computer, a digital camera, an MP3 player, or the like.

In addition, the secondary battery has been focused as a power source of an electric vehicle (EV), a hybrid electric vehicle (HEV), etc., that have been suggested as a scheme for solving air pollution of an existing gasoline vehicle, diesel vehicle, etc., using a fossil fuel.

The battery module formed as the secondary battery configured by one battery cell or a few battery cells per one device may be used in the small mobile devices. On the other hand, a middle or large-sized battery module configured by electrically connecting a plurality of battery cells may be used in middle or large-sized devices such as a car, or the like due to a need of high output and large capacity.

The battery module is manufactured in various shapes. In particular, in order to be used to drive devices requiring large power, for example, a motor for an electric car, or the like, the middle or large-sized battery module is configured by connecting the plurality of high-output battery cells in series.

In this case, it is preferable to manufacture the middle and large-sized battery module at the possible small size and weight. Therefore, a square type battery, a pouch type battery, or the like, that can be integrated at high integration and have a small weight compared with capacity have been mainly used as a battery cell of the middle and large-sized battery module.

Meanwhile, the battery cells configuring the middle and large-sized battery module are configured by a secondary battery that can be charged and discharged and thus, a considerable amount of heat is generated during a charging and discharging process. In this case, when the heat of the battery cell generated during the charging and discharging process is not effectively removed, heat is accumulated and thus, the deterioration of the battery cell is promoted, thereby degrading the charging and discharging efficiency. In some cases, there is a risk of ignition or explosion. Therefore, the middle and large-sized battery module that is a high output and large-capacity battery needs a battery pack case including a cooling system capable of cooling the built-in battery cells.

The battery pack case according to the related art is provided with cooling passages passing through an outer surface of the battery pack case and penetrating through the inside thereof so as to improve cooling efficiency. The cooling passages are a cause of making the structure complicated and increasing a volume of the battery pack case.

Therefore, the battery pack case having a structure in which a refrigerant inlet and a refrigerant outlet are disposed on a top portion and a bottom portion of the battery pack case in a direction opposite to each other and a top surface and a bottom surface of a flowing space from the refrigerant inlet to the battery cell are parallel with each other. However, in the structure, a flux is mainly introduced into passages between the battery cells around the refrigerant outlet and a flux is largely reduced in passages around the refrigerant inlet and thus, it is difficult to implement uniform cooling between the battery cells.

Further, in order to uniformly contact a cooling medium with each battery cell of the battery pack case, a power supply for moving the cooling medium has been used and thus, additional power may be consumed so as to move the cooling medium through the power source.

### RELATED ART DOCUMENT

### Patent Document

(Patent Document 1) KR 10-2006-0037601A
(Patent Document 2) KR 10-2006-0037627 A

### SUMMARY OF THE INVENTION

An object of the present invention is to provide a battery pack case capable of increasing cooling efficiency by dissipating heat from a front surface of a battery cell and making an amount of a cooling medium supplied to each battery cell uniform.

Another object of the present invention is to provide a battery pack case capable of automatically moving a cooling medium without using a power source for moving the cooling medium.

Still another object of the present invention is to provide a battery pack case capable of simply replacing battery cells embedded in a battery pack case.

According to an exemplary embodiment of the present invention, there is provided a battery pack case, including: at least one battery cell: a cooling case having inclinedly formed insertion parts into which the battery cells are inserted; and cooling passages provided in the cooling case and inclinedly formed so as to move a cooling medium between the battery cells.

The cooling case may include: a refrigerant inlet formed at one side of the cooling passages to be introduced with the cooling medium; and a refrigerant outlet formed at the other side of the cooling passage to discharge the cooling medium passing through the battery cells.

The refrigerant inlet may be formed above the refrigerant outlet.

The cooling case may be made of any one of aluminum, copper, iron, stainless steel, ceramic, and polymer.

The battery cell may have terminals protrudedly formed in a bilateral direction.

The battery cell may be a square type.

The cooling medium may be cooling water.

According to another exemplary embodiment of the present invention, there is provided a battery pack case, including: at least one battery cell; a cooling case having inclinedly formed insertion parts into which the battery cells are inserted; fixing parts formed in insertion parts to fix the battery cells; and cooling passages provided in the cooling case and inclinedly formed to move a cooling medium between the battery cells.

The cooling case may include: a refrigerant inlet formed at one side of the cooling passage to be introduced with the cooling medium; and a refrigerant outlet formed at the other side of the cooling passage to discharge the cooling medium passing through the battery cells.

The refrigerant inlet may be formed above the refrigerant outlet.

The cooling case may be made of any one of aluminum, copper, iron, stainless steel, ceramic, and polymer.

The battery cell may have terminals protrudedly formed in a bilateral direction.

The battery cell may be a square type.

The cooling medium may be cooling water.

### BRIEF DESCRIPTION OF THE DRAWINGS

FIG. 1 is a perspective view schematically showing a battery pack case according to an exemplary embodiment of the present invention.

FIG. 2 is a partially cutaway perspective view schematically showing the battery pack case according to the exemplary embodiment of the present invention.

FIG. 3 is a cross-sectional view schematically showing a battery pack case according to an exemplary embodiment of the present invention.

FIG. 4 is a perspective view showing a shape in which battery cells are removed from the battery pack case.

FIG. 5 is a perspective view schematically showing the battery cells.

FIG. 6 is a perspective view schematically showing a battery pack case according to another exemplary embodiment of the present invention.

FIG. 7 is a cross-sectional view showing a battery pack case of FIG. 6.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

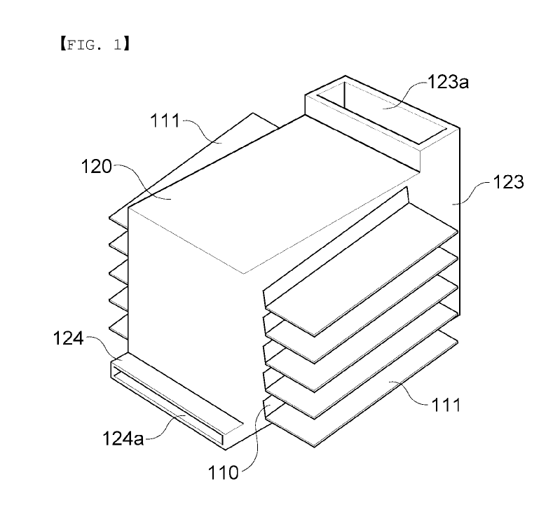

Hereinafter, a battery pack case according to exemplary embodiments of the present invention will be described in more detail with reference to FIGS. 1 to 5.

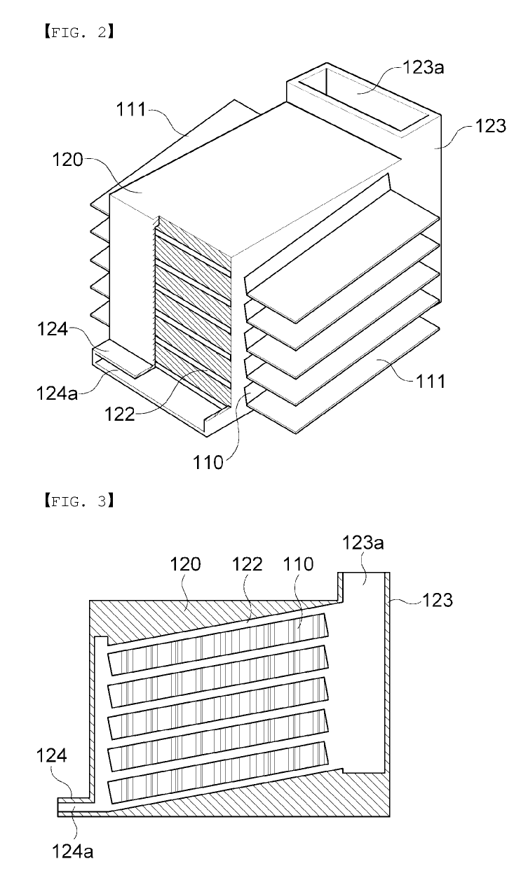

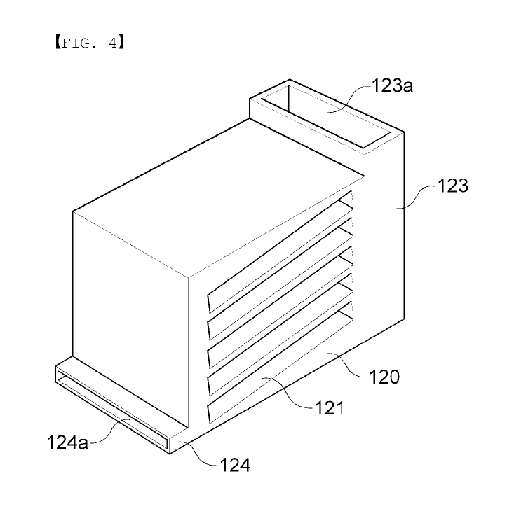

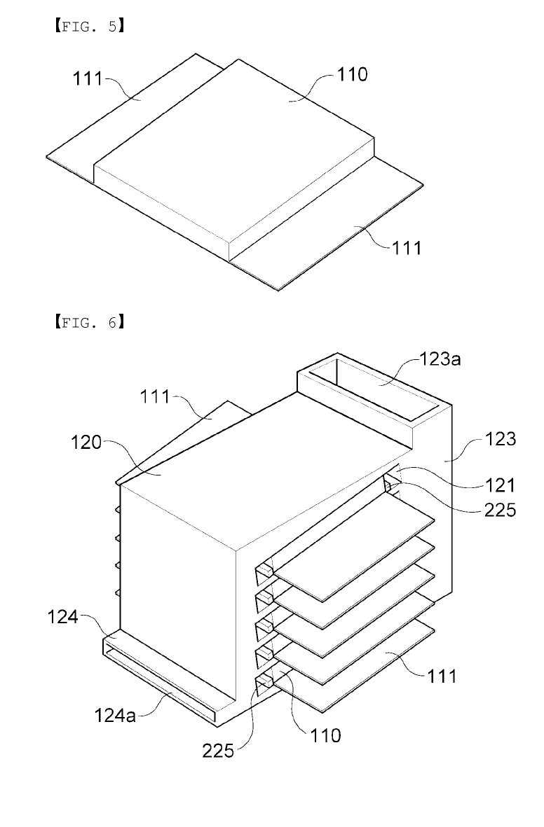

FIG. 1 is a perspective view schematically showing a battery pack case according to an exemplary embodiment of the present invention, FIG. 2 is a partially cutaway perspective view schematically showing the battery pack case according to the exemplary embodiment of the present invention, FIG. 3 is a cross-sectional view schematically showing a battery pack case according to an exemplary embodiment of the present invention, FIG. 4 is a perspective view showing a shape in which battery cells are removed from the battery pack case, and FIG. 5 is a perspective view schematically showing the battery cells.

As shown in FIGS. 1 to 5, the battery pack case according to the exemplary embodiments of the present invention may include at least one battery cell 110, a cooling case 120 having inclinedly formed insertion parts 121 into which the battery cells 110 are inserted, and cooling passages 122 provided in the cooling case 120 and inclinedly formed so as to move a cooling medium between the battery cells 110.

Further, the cooling case 120 may include a refrigerant inlet 123 formed at one side of the cooling passage 122 to be introduced with a cooling medium and a refrigerant outlet 124 formed at the other side of the cooling passage 122 to discharge the cooling medium passing through the cooling passages 122.

The battery cell 110 may be configured by a secondary battery having a general structure configured to include an electrode assembly including an anode plate and a cathode plate having a separator disposed therebetween, a case in which the electrode assembly is embedded, a cap assembly coupled with the case and sealing the case, and an anode terminal and a cathode terminal protruded to the cap assembly and electrically connected to a collector of an anode plate and a cathode plate included in the electrode assembly, thereby charging and discharging predetermined positive power.

The secondary battery having the above-mentioned structure according to the exemplary embodiment of the present invention, a square type battery cell 110 of which the anode and cathode terminals 111 are protruded to both sides may be preferably formed.

The cooling case 120 is provided with the insertion parts 121 into which the battery cells 110 are inserted, thereby cooling the inserted battery cells 110.

In this case, the cooling case 120 may be made of any one selected from aluminum (Al), copper (Cu), iron (Fe), stainless steel (SUS), ceramic, polymer, and an equivalent thereof.

Herein, the insertion parts 121 are formed penetrating through the side of the cooling case 120. In this case, the plurality of insertion parts 120 may be formed to penetrate through in a vertical direction at a predetermined distance so that the inserted battery cells 110 may be inserted in a vertically stacked form. In addition, the insertion parts 121 may be formed to be inclined at a predetermined angle so that the battery cells 110 are inclinedly inserted thereinto.

In this case, the size of the insertion part 121 is formed at the same size as the size of the battery cell 110 and thus, the battery cells 110 may be formed so as to contact the inner sides of the insertion parts 121 at the time of inserting the battery cells 110 thereinto.

That is, the battery cells 110 are inserted so that the front surfaces of the battery cells 110 other than both sides on which the terminals 111 are formed contact the inner sides of the insertion parts 121, thereby performing simultaneous cooling over the wide area and thus, increasing the cooling efficiency for the battery cells 110.

In addition, when coupling the insertion parts 121 with the battery cells 110, the terminals 111 formed at both sides of the battery cells 110 are inserted into the side of the cooling case 120 in a slide manner so that the terminals are protruded to the outside of the cooling case 120, thereby making the manufacturing process simple and when replacing the battery cells 110, only the corresponding battery cells 110 to be replaced can be separated in the slide manner, thereby easily replacing the battery cells 110.

Herein, the battery cells 110 inserted into the insertion parts 121 of the cooling case 120 may be stacked and the terminals 111 arranged in series so as to be adjacent to each other may be connected with each other in a serial manner and/or in a parallel manner.

In this case, the coupling of the terminals 111 may be implemented in various manners such as the mechanical fastening using welding, soldering, bolt, and nut. Preferably, the coupling of the terminals 111 can be implemented by the welding.

Further, a gap between the insertion parts 121 of the cooling case 120 may be formed with the cooling passages 122 that are a space through which the cooling medium flows.

Here, the cooling passages 122 are formed in barrier ribs between the insertion parts 121 and is inclinedly formed at an angle enough to smoothly move the cooling medium passing through between the battery cells 110. In this case, the inclined angle of the cooling passage is not particularly limited to any specific value if smooth flowing of the cooling medium is implemented.

Further, the cooling case 120 may include a flowing space, that is, a refrigerant inlet 123 that is formed at one side of the cooling passage 122 to temporarily store the cooling medium supplied through the inlet 123a and then, introduce the cooling medium into the cooling passage 122 and a flowing space, that is, a refrigerant outlet 124 that is formed at the other side of the cooling passage 122 to discharge the cooling medium passing through the cooling passage 122 to an outlet 124a.

Herein, the inlet 123a is integrally formed above one side of the cooling case 120 so as to supply the cooling medium to the refrigerant inlet 123 of the cooling case 120 and an outlet 124a may be integrally formed below the other side thereof so as to discharge the cooling medium passing through the cooling passages 122 to the outside.

In this case, the refrigerant inlet 123 is formed above the refrigerant outlet 124 and the insertion part 121 and the cooling passage 122 may be formed to be downwardly inclined from the refrigerant inlet 123 to the refrigerant outlet 124.

Therefore, the cooling medium is supplied to the refrigerant inlet 123 through the inlet 123a and flows to the refrigerant outlet 124 formed below than the refrigerant inlet 123. In this case, the cooling medium supplied to the refrigerant inlet 123 is formed between the battery cells 110 to cool the battery cells 110 while passing through the cooling passages 122 downwardly inclined so as to communicate the refrigerant inlet 123 with the refrigerant outlet 124 and may be discharged to the outlet 124a through the refrigerant outlet 124.

That is, the cooling medium naturally flows through the refrigerant inlet 123 and the refrigerant outlet 124 formed at different heights and the cooling passages 122 inclinedly formed and connecting the refrigerant inlet 123 with the refrigerant outlet 124 and thus, a separate power source for moving the cooling medium is not needed, thereby reducing the additional power consumption for moving the cooling medium and reducing the production costs and the maintenance costs.

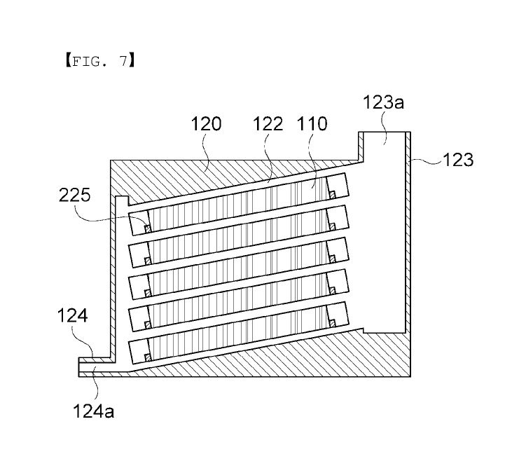

FIG. 6 is a perspective view schematically showing a battery pack case according to another exemplary embodiment of the present invention and FIG. 7 is a cross-sectional view showing a battery pack case of FIG. 6.

As shown in FIGS. 6 and 7, the battery pack case according to another exemplary embodiment of the present invention is an exemplary embodiment of the case in which the size of the battery cell 110 inserted into the cooling case 120 is small. The battery pack case may include at least one battery cell 110, a cooling case 120 having the inclinedly formed insertion parts 121 into which the battery cells 110 are inserted, fixing parts 225 formed in the insertion parts 121 to fix the battery cells 110, the cooling passages 122 provided in the cooling case 120 and inclinedly formed so as to move the cooling medium between the battery cells 110, wherein the cooling case 120 may include the refrigerant inlet formed at one side of the cooling passage 122 to be introduced with the cooling medium and a refrigerant outlet 124 formed at the other side of the cooling passage 122 to discharge the cooling medium passing through the battery cells 110.

In this case, the remaining components other than the insertion other than the insertion parts 121 formed with the fixing parts 225 are the same as the above-mentioned exemplary embodiments and therefore, the detailed description thereof will be omitted.

The fixing part 225 may be formed on the bottom surface of the inner side of the insertion part 121 into which the battery cell 110 is inserted so as to support and fix one side and the other side of the battery cell 110.

That is, when the size of the battery cell 110 inserted into the insertion part 121 is small, the fixing part 225 is formed on the bottom surface of the inner side of the insertion part 121 so as to correspond to the width of the battery cell 110, the battery cell 110 is inserted between the fixing parts 225 to fix the one side and the other side of the battery cell 110 to prevent the battery cells 110 from moving, and the space in which air can flow is formed at one side and the other side of the battery cell 110, thereby more efficiently cooling the battery cells 110.

As set forth above, the battery pack case according to the exemplary embodiments of the present invention can increase the cooling efficiency for the battery cells and increase the lifespan of the battery cells by contacting the cooling passages to the front surfaces of the battery cells other than the connection terminal and uniformly supplying the amount of cooling medium to each battery cell.

Further, the exemplary embodiments of the present invention can reduce the consumption of additional power for moving the cooling medium and reduce the production costs and the maintenance costs because the power source for moving the cooling medium can be removed by automatically moving the cooling medium supplied by the height difference due to the inclinedly formed cooling passages.

In addition, the exemplary embodiment of the present invention can make the manufacturing process simple by inserting the battery cells by the slide method and make the maintenance simple by replacing only the corresponding battery cells at the time of replacing the battery cells.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A battery pack case, comprising:
at least one battery cell:
a cooling case having inclinedly formed insertion parts into which the battery cells are inserted; and
cooling passages provided in the cooling case and inclinedly formed so as to move a cooling medium between the battery cells.

2. The battery pack case according to claim 1, wherein the cooling case includes:
a refrigerant inlet formed at one side of the cooling passage to be introduced with the cooling medium; and
a refrigerant outlet formed at the other side of the cooling passage to discharge the cooling medium passing through the battery cells.

3. The battery pack case according to claim 2, wherein the refrigerant inlet is formed above the refrigerant outlet.

4. The battery pack case according to claim 1, wherein the cooling case is made of any one of aluminum, copper, iron, stainless steel, ceramic, and polymer.

5. The battery pack case according to claim 1, wherein the battery cell has terminals protrudedly formed in a bilateral direction.

6. The battery pack case according to claim 1, wherein the battery cell is a square type.

7. The battery pack case according to claim 1, wherein the cooling medium is cooling water.

8. A battery pack case, comprising:
at least one battery cell;
a cooling case having inclinedly formed insertion parts into which the battery cells are inserted;
fixing parts formed in insertion parts to fix the battery cells; and
cooling passages provided in the cooling case and inclinedly formed to move a cooling medium between the battery cells.

9. The battery pack case according to claim 8, wherein the cooling case includes:
a refrigerant inlet formed at one side of the cooling passage to be introduced with the cooling medium; and
a refrigerant outlet formed at the other side of the cooling passage to discharge the cooling medium passing through the battery cells.

10. The battery pack case according to claim 9, wherein the refrigerant inlet is formed above the refrigerant outlet.

11. The battery pack case according to claim 8, wherein the cooling case is made of any one of aluminum, copper, iron, stainless steel, ceramic, and polymer.

12. The battery pack case according to claim 8, wherein the battery cell has terminals protrudedly formed in a bilateral direction.

13. The battery pack case according to claim 8, wherein the battery cell is a square type.

14. The battery pack case according to claim 8, wherein the cooling medium is cooling water.
